(19) United States
(12) Patent Application Publication
(10) Pub. No.: US 2016/0357847 A1
(43) Pub. Date: Dec. 8, 2016

(54) COMPUTER READABLE MEDIUM, METHOD, AND INFORMATION PROCESSING APPARATUS

(71) Applicant: FUJITSU LIMITED, Kawasaki-shi (JP)

(72) Inventors: Tsuguchika Tabaru, Machida (JP); Motoyuki Kawaba, Kawasaki (JP)

(73) Assignee: FUJITSU LIMITED, Kawasaki-shi (JP)

(21) Appl. No.: 15/168,348

(22) Filed: May 31, 2016

(30) Foreign Application Priority Data
Jun. 5, 2015 (JP) 2015-115286

(51) Int. Cl. G06F 17/30

(52) U.S. Cl. CPC G06F 17/30598; G06F 17/30327; G06F 17/30424; G06F 17/30486

(57) ABSTRACT

A method includes: reading, when each of a plurality of pieces of data is set as target data to be grouped and the target data is grouped based on boundary value of a root node in a binary tree, the target data from the plurality of pieces of data, specifying a temporary maximum value that indicates a maximum value among the target data and data already grouped, and a temporary minimum value that indicates a minimum value among the target data to be grouped and the data already grouped; specifying a maximum value and a minimum value of the plurality of pieces of data by updating the temporary maximum value and the temporary minimum value; and dividing the plurality of pieces of data based on a boundary value between the maximum value and the minimum value of the plurality of pieces of data among the plurality of boundary values.

### CROSS-REFERENCE TO RELATED APPLICATION

This application is based upon and claims the benefit of priority of the prior Japanese Patent Application No. 2015-115286, filed on Jun. 5, 2015, the entire contents of which are incorporated herein by reference.

### FIELD

The embodiments discussed herein relate to a computer readable medium, a method, and an information processing apparatus.

### BACKGROUND

Software techniques for a computer include, for example, a technique related to a sort process for rearranging a plurality of pieces of data in order according to a certain sequence. The sort process may include rearranging numerical values, for example, in order from the largest or in order from the smallest, rearranging character strings in alphabetic order or in Japanese alphabetic order, or rearranging dates in order from the oldest or from the newest.

A technique for increasing the speed of the sort process involves dividing one sort process and carrying out the processing in a plurality of processors or processor cores concurrently. For example, when one sort process is carried out concurrently in a plurality of processors, the plurality of pieces of data to be rearranged is divided into a plurality of data groups. The speed of the sorting can be increased by allocating the data groups to each of the plurality of processors and carrying out the rearranging, and then combining the obtained plurality of rearranging results.

With respect to the above matter, a technique is known in which a sorting method is automatically selected according to the properties and amounts of the data to be sorted to increase the speed of the sorting. Another technique is known that provides a sorting method that reduces the sort processing time due to the sort process in which data to be sorted is divided into N number of groups, and the amount of the data is reduced by the dividing. A technique is known that reduces unnecessary exchange processing as much as possible and that classifies a plurality of given record values as equally as possible when classifying the given record values into two groups. A technique is known that improves performance by greatly reducing the number of branch prediction errors (see Japanese Laid-open Patent Publication No. 2014-102613 for example). A technique is known in which a display or a printed matter can be easily understood visually while enabling the recognition of sequences or groupings of data spread between groupings.

Related techniques are discussed in, for example, Japanese Laid-open Patent Publication No. 2002-116907, Japanese Laid-open Patent Publication No. 2012-185791, Japanese Laid-open Patent Publication No. 5-143286, Japanese Laid-open Patent Publication No. 2014-102613, and Japanese Laid-open Patent Publication No. 2006-268688.

### SUMMARY

According to an aspect of the invention, a method includes: reading, when each of a plurality of pieces of data is set as target data to be grouped and the target data is grouped based on a boundary value of a root node in a binary tree created from a plurality of boundary values, the target data from the plurality of pieces of data, specifying, by a processor, a temporary maximum value that indicates a maximum value among the target data and data already grouped, and a temporary minimum value that indicates a minimum value among the target data to be grouped and the data already grouped; specifying, by the processor, a maximum value and a minimum value of the plurality of pieces of data by updating the temporary maximum value and the temporary minimum value; dividing, by the processor, the plurality of pieces of data based on a boundary value between the maximum value and the minimum value of the plurality of pieces of data among the plurality of boundary values; and allocating, by the processor, the divided plurality of pieces of data to a plurality of processing devices that carry out processing on each of the divided plurality of data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a sort process for dividing data using a binary tree;

FIG. 2 illustrates an example of grouping a plurality of pieces of data into a plurality of division segments using a binary tree;

FIG. 3 illustrates an example of a database of data having a bias;

FIG. 4 illustrates an example of a binary tree created using a boundary value in a range of the data having a bias;

FIG. 5 illustrates an example of an action flow for division processing using a binary tree that uses maximum and minimum values and the number of comparisons of the process;

FIG. 6 illustrates an example of a functional block configuration of an information processing apparatus according to an embodiment;

FIGS. 7A, 7B, and 7C illustrate an example of a binary tree created according to magnitude relationships between a temporary maximum value, a temporary minimum value, and a boundary value of a root node;

FIG. 8 illustrates an example of transitioning of states;

FIG. 9 illustrates an example of an action flow for a grouping process based on the boundary value of the root node in a state 1;

FIG. 10 illustrates an example of an action flow for a grouping process based on the boundary value of the root node in a state 2;

FIG. 11 illustrates an example of an action flow for a grouping process based on the boundary value of the root node in a state 3;

FIG. 12 illustrates an example of an action flow for a grouping process based on the boundary value of the root node in a state 4;

FIG. 13 illustrates an example of an action flow for finish confirmation processing;

FIG. 14 illustrates an example of an action flow for division completion processing using maximum and minimum values;

FIG. 15 illustrates an example of an action flow for second division completion processing; and

FIG. 16 illustrates an example of a hardware configuration of a system according to a first embodiment.

### DESCRIPTION OF EMBODIMENTS

In order to carry out concurrent processing, there is a method for using a binary tree to group a plurality of pieces of data into a plurality of division segments as one example of dividing a plurality of pieces of data to be sorted. A plurality of boundary values (pivots) which act as boundaries for dividing the data are determined in this method. By using the data to search a binary tree created from the plurality of boundary values, the plurality of pieces of data is grouped into a plurality of division segments demarcated (or partitioned) by the boundary values. For example, when the boundary values are −5, 0, 5, the plurality of pieces of data may be divided into four division segments of less than −5, −5 and greater to less than 0, 0 and greater to less than 5, and 5 and greater. In this case, magnitude relationships are determined among the plurality of division segments demarcated by the boundary values. As a result, the sorting can be completed at a higher speed by allocating the data included in the division segments to a plurality of processors to carry out rearranging and then combining the obtained plurality of rearranging results according to the magnitude relationships of the division segments. However, the amount of data to be handled has been increasing in recent years and there is a desire to further reduce the computing load in the sort process. An object according to one aspect of the embodiment is to provide a technique that is capable of reducing the number of comparisons when using a binary tree to divide a plurality of data.

According to the one aspect of the disclosed embodiment, a technique is provided that reduces the number of comparisons when using a binary tree to divide a plurality of data.

Hereinafter, embodiments will be described with reference to the drawings. The same reference numerals are attached to the corresponding elements in the drawings.

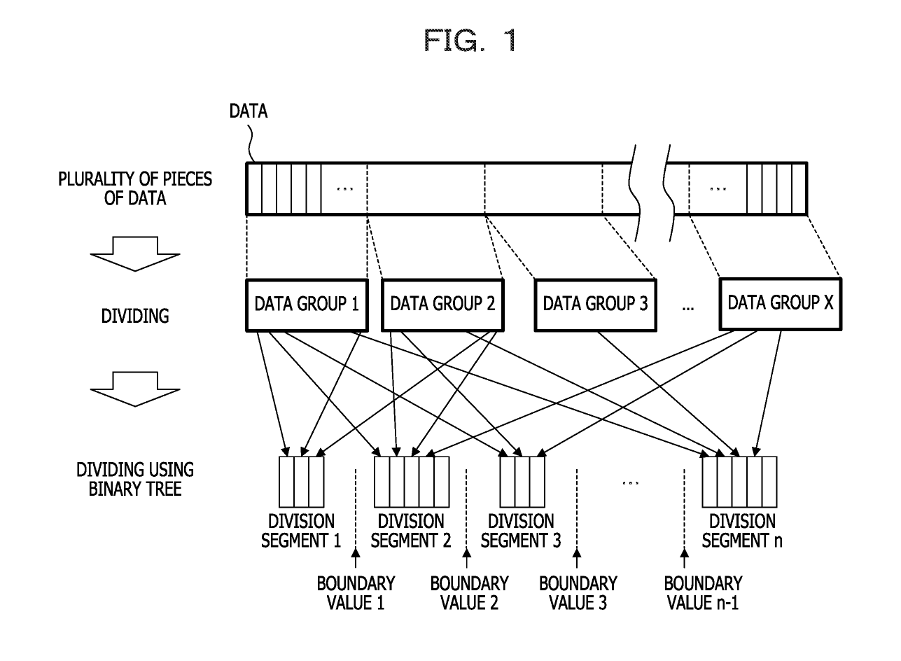

FIG. 1 illustrates an example of a sort process for dividing data using a binary tree. The method depicted in FIG. 1 involves dividing a plurality of pieces of data to be sorted into a plurality of data groups (for example, data group 1 to data group X in FIG. 1) to carry out concurrent processing of the data among a plurality of processors. The dividing may be carried out, for example, so that the amount of data included in each of the plurality of data groups after dividing is approximately equal. Next, the plurality of data groups after the dividing are allocated to any of the plurality of processors. The processors then use the data included in the allocated data groups to search a binary tree created from, for example, a plurality of preset boundary values. Consequently, the processors group the data included in the allocated data groups into a plurality of division segments (for example, division segment 1 to division segment n in FIG. 1) using a plurality of boundary values as boundaries, and divide the plurality of pieces of data included in the data groups. The plurality of boundary values used for the dividing may be determined according to various methods. For example, the plurality of boundary values may be determined and set based on a distribution obtained by sampling the plurality of pieces of data to be divided.

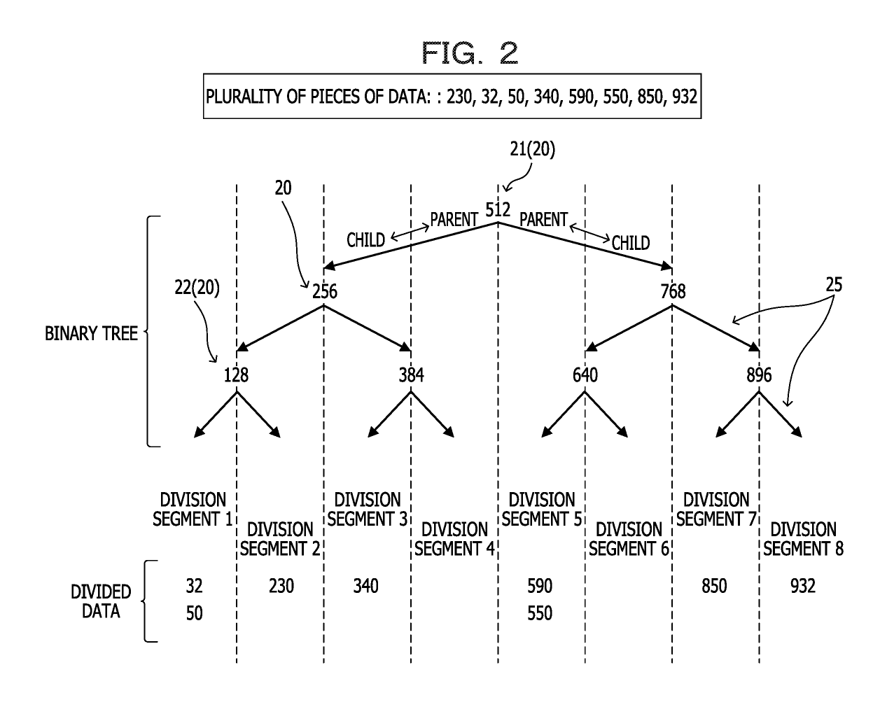

FIG. 2 illustrates an example of dividing a plurality of pieces of data into a plurality of division segments using a binary tree. Seven values of 128, 256, 384, 512, 640, 768, and 896 are set and a binary tree is created from the seven boundary values as depicted in the example in FIG. 2. The boundary values are used as nodes 20 in the binary tree. In the following explanation, a node arranged on a left side or right side branch 25 of a given node 20 may be called a child node of the given node 20. The node 20 that has the child node may be called a parent node with respect to the child node. The binary tree may be created as a tree structure so that, for example, the magnitude relationship of left side child node<parent node≦right side child node (or, left side child node≦parent node<right side child node) is satisfied. The highest node 20 that does not have a parent node in the binary tree is a root node 21, and the boundary value: 512 is the root node 21, for example, in FIG. 2. The terminal node 20 that does not have a child node in the binary tree is a leaf node 22, and the boundary values: 128, 384, 640, 896 are the leaf nodes 22, for example, in FIG. 2.

Dividing a plurality of pieces of data into a plurality of division segments using the binary tree will be discussed next. As mentioned above, the plurality of pieces of data is grouped into any of the plurality of division segments (for example, division segment 1 to division segment 8 in FIG. 2) using the boundary values as boundaries included in the binary tree and consequently the plurality of pieces of data is divided when carrying out division using a binary tree. For example, it is assumed that the data values: 230, 32, 50, 340, 590, 550, 850, 932 are present in the plurality of pieces of data. For example, when using the data value: 230 to search the binary tree in FIG. 2, the data value: 230 is first compared with the boundary value: 512 that is the root node 21. Because the data value: 230 is smaller than the boundary value: 512, the data value: 230 is grouped into the left side branch 25 and then the data value: 230 is compared to the boundary value: 256. Because the data value: 230 is smaller than the boundary value: 256, the data value: 230 is grouped into the left side branch 25 and then the data value: 230 is compared to the boundary value: 128. Because the data value: 230 is large than the boundary value: 128, the data value: 230 is grouped into the right side branch 25. The searching is finished because the boundary value: 128 is the leaf node 22, and the data value: 230 is grouped in the division segment 2 between the boundary value: 128 and the boundary value: 256. The remaining data values: 32, 50, 340, 590, 550, 850, 932 included in the plurality of pieces of data can be similarly grouped into any of the segments of the division segment 1 to division segment 8 by searching the binary tree in order from the root node 21 to the leaf node 22. As a result, the divided data can be achieved as illustrated in FIG. 2.

By searching the binary tree as described above, for example, when the data divided into the data group 1 to the data group X in FIG. 1 is obtained and collected in each division segment, the plurality of pieces of data can be made into divided data that is grouped into any of the division segment 1 to division segment n. In this case, magnitude relationships are determined among the plurality of division segments demarcated by the boundary values. As a result, the sorting can be completed at a higher speed by allocating the data included in the division segments to a plurality of processors to carry out sorting and then combining the obtained plurality of sorting results according to the magnitude relationships of the division segments. However, the amount of data to be handled has been increasing in recent years and there is a desire to further reduce the computing load in the sorting process.

In order to reduce the amount of computing for dividing using the binary tree, it has been considered to use a bias of the data inside the data group to be divided, for example. A bias of the data may be a bias toward a range having a larger amount of data in segments in a certain row when the data in a certain data group, for example, is lined up.

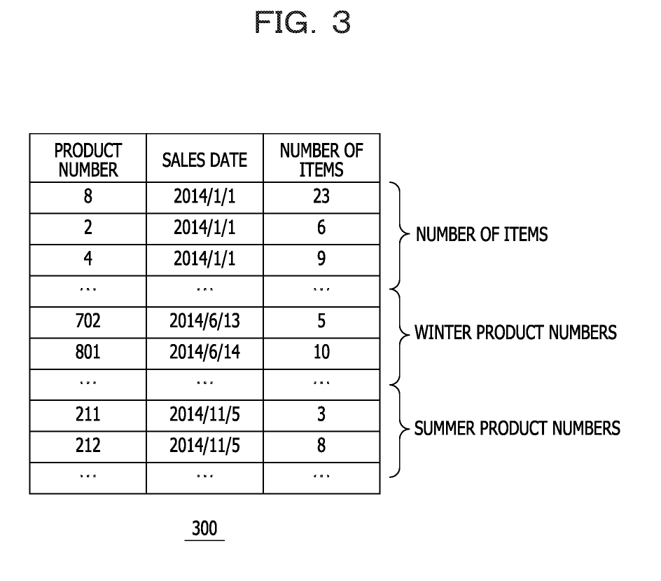

FIG. 3 illustrates an example of a database data having a bias, and illustrates a sales database 300 of products. Product numbers which are identifiers for identifying a product, sales dates which indicate when a product identified by the product number was sold, and the number of items are registered in the sales database 300 in FIG. 3 in association with each other and in order of the sales dates. When, for example, the sold products are sorted in each season, a bias in the alignment of the product numbers is created so that the product numbers of the products sold in the winter among the winter period sales dates are lined up and the product numbers of the products sold in the summer among the summer period sales dates are lined up. Then, for example, the product numbers in the sales database 300 in FIG. 3 are made into data and the data is divided into units of predetermined numbers in order from the top to obtain plurality of data groups. In this case for example, it is possible that only the product numbers of the winter period products would be included in a certain data group among the obtained plurality of data groups, and on the other hand, only the product numbers of the summer period products would be included in another data group.

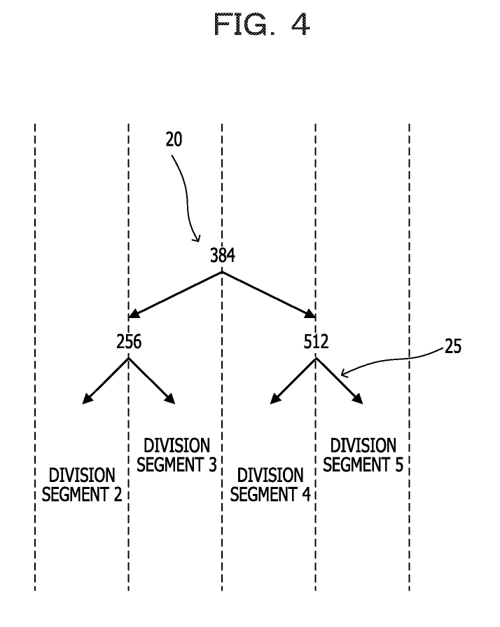

For example, it is assumed that only the product numbers of the summer period products are included in a certain data group, and moreover, numbers from 251 to 600 are allocated to the product numbers of the summer period products. In this case, the product numbers included in the data group are biased toward values between 251 to 600. If the data included in the data group is grouped by using the boundary values as boundaries depicted in FIG. 2 for example, it can be seen that the grouping destination of the data is any of division segments 2 to 5 and the data is not grouped in division segment 1 or division segments 6 to 8 due to the range: 251 to 600 of the bias of the product numbers. As a result for example, if dividing is carried out using a binary tree (FIG. 4 for example) created by using boundary values: 256, 384, 512 within the range: 251 to 600 of the bias of the data, the division segments that are the grouping destinations of the data can be specified. In this way, if it is known that the data included in a data group is biased toward a certain range, the dividing is not needed to be carried out by using a binary tree created from all of the preset boundary values, and, for example, the dividing may be carried out by using a binary tree created from boundary values within the range of the bias. Therefore, the number of comparisons for the dividing can be reduced. Data groups that have already been sorted may also be included as an example of a data group having a bias.

The range of the bias of the data included in the data group can be specified, for example, from the maximum value and the minimum value of the data included in the data group. Accordingly, it may be considered that the maximum and minimum values of the data included in the data group can be specified before executing the dividing using a binary tree on the data included in the data group.

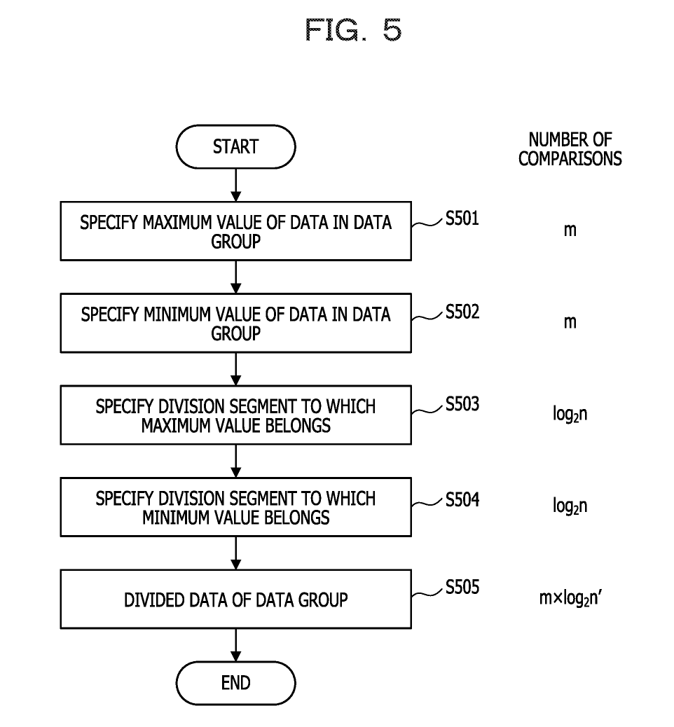

FIG. 5 illustrates an example of an action flow of division processing using a binary tree that uses the maximum and minimum values of data included in a data group, and illustrates an example of the number of comparisons in the processing. An information processing apparatus may start the action flow depicted in FIG. 5 when, for example, information instructing the execution of the division is inputted.

In step S501 (hereinbelow, “step” is written as “S” and expressed as “S501” for example), the information processing apparatus specifies the maximum value of the data included in the data group to be divided. The specification of the maximum value may be executed as described below for example. First, a predetermined initial value is previously set as the maximum value. The information processing apparatus then compares the maximum value with data read from the data group, and if the read data is greater than the set maximum value, the maximum value is updated to the read data. This processing is executed on all of the data included in the data group whereby the information processing apparatus is able to specify the maximum value of the data in the data group. In this case, the number of comparisons used to specify the maximum value may be estimated as “m” number of times which is the number of the data included in the data group, and one comparison is carried out with regard to each data to specify the maximum value. In S502, the information processing apparatus specifies the minimum value of the data included in the data group to be divided. The number of comparisons used to specify the minimum value may be estimated, for example, as “m” number of times and one comparison is carried out with regard to each data.

In S503, the information processing apparatus specifies the division segment to which the maximum value belongs from among the plurality of division segments demarcated by the predetermined plurality of boundary values. The information processing apparatus may use, for example, the value specified as the maximum value to search the binary tree created from the set plurality of boundary values to specify the division segment to which the maximum value belongs. In this case, the number of comparisons used to specify the division segment to which the maximum value belongs may be estimated as “log₂ n”, where n is a value equal to or greater than the number of the plurality of division segments demarcated by the plurality of preset boundary values and may be a value to the power of 2. In S504, the information processing apparatus specifies the division segment to which the minimum value belongs from among the plurality of division segments demarcated by the plurality of preset boundary values. The number of comparisons used to specify the division segment to which the minimum value belongs may be estimated as “log₂ n”. In S505, the information processing apparatus uses the boundary value between the maximum value and the minimum value among the set plurality of boundary values to create a binary tree. The information processing apparatus then uses the created binary tree to divide the data included in the data group into division segments, and then the action flow is finished. The number of comparisons for the division processing in S505 may be estimated to be “m×log₂ n′” where n is a value equal to or greater than the number of the plurality of division segments from the division segment to which the maximum value belongs to the division segment to which the minimum value belongs and may be a value to the power of 2.

For example, by carrying out the action flow depicted above in FIG. 5, a bias of the data included in the data group can be specified from the maximum value and the minimum value and dividing can be carried out using the binary tree. If, for example, there is a bias in the data included in the data group, the number of comparisons can be reduced because the size of the binary tree used in the division processing as described above can be reduced. However, if as a result of deriving the maximum value and the minimum value, the data is spread over the entire plurality of division segments for example, the size of the binary tree is not reduced and the number of comparisons is not reduced. Moreover, in this case, the amount of computations for comparing to derive the maximum value and the minimum value may increase. For example, when grouping the data included in the data group into 1024 division segments demarcated by the boundary values, if 10 comparisons with regard to each data are conducted following the binary tree because log₂ 1024=10, the data can be grouped into any of the division segments. However in the example in FIG. 5, because one comparison for specifying the maximum value and one comparison for specifying the minimum value with regard to the data are carried out for a total of two comparisons, the processing is increased by 20 percent if there is no bias in the data included in the data group. As a result, a technique is desired for reducing the number of comparisons that are carried out when specifying the maximum value and the minimum value of the data included in a certain data group and when dividing the data included in the data group using a binary tree.

In the embodiment discussed below, processing for specifying the maximum value and the minimum value of data included in a data group is combined with processing to group the data included in the data group based on the boundary value of the root node 21 in the binary tree. As a result, the number of comparisons used to specify the maximum value and the minimum value in the data included in the data group can be reduced when grouping the data included in the data group using the boundary value of the root node 21 as the boundary. The binary tree may be created as a tree structure so that, for example, the magnitude relationship of the left side child node<parent node≦right side child node is satisfied in the embodiment discussed below. However, the structure of the binary tree used in the embodiment is not limited to this structure and another binary tree may be used. For example, in another embodiment, a binary tree may be created so that the magnitude relationships of left side child node≦parent node<right side child node, left side child node>parent node≧right side child node, or left side child node≧parent node>right side child node, and the like are satisfied. Furthermore, a binary tree for satisfying these types of magnitude relationships may be referred to as a binary search tree hereinbelow.

### Embodiment

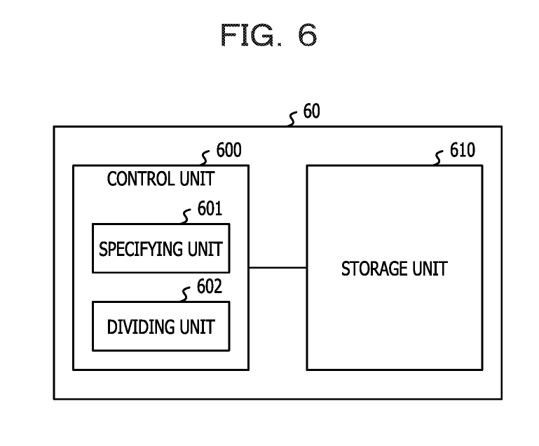

FIG. 6 illustrates an example of a functional block configuration of an information processing apparatus 60 according to the embodiment. The information processing apparatus 60 may be, for example, a computer in which a database system can operate. The information processing apparatus 60 includes, for example, a control unit 600 and a storage unit 610. The control unit 600 may control the units in the information processing apparatus 60 including the storage unit 610. Moreover, the control unit 600 includes, for example, a specifying unit 601 and a dividing unit 602, and the like. The control unit 600 of the information processing apparatus 60 may function as a functional unit such as the specifying unit 601 and the dividing unit 602 by using, for example, the storage unit 610 and reading and executing programs. The functional units are described in detail below.

As discussed above, two comparisons with regard to each data included in the data group are carried out when specifying the maximum value and the minimum value of the data included in a certain data group in the example in FIG. 5. The grouping of the data included in the data group using the boundary value of the root node 21 as the boundary in the binary tree can be executed, for example, by comparing each of the data included in the data group with the boundary value of the root node 21 and grouping the data into a group equal to or greater than the boundary value of the root node 21 and a group less than the boundary value of the root node 21. In this case, the grouping using the boundary value of the root node 21 as the boundary in the binary tree involves carrying out one comparison with regard to each data. Therefore for example, three comparisons with regard to each data are carried out when specifying the maximum value and the minimum value of the data included in the data group and grouping the data using the boundary value of the root node 21 as the boundary. However, the number of comparisons can be reduced as described below when the processing for specifying the maximum value and the minimum value of the data included in the data group is combined with the grouping of the data included in the data group using the boundary value of the root node 21 as the boundary in the binary tree.

For example, it is assumed that a temporary maximum value and a temporary minimum value are specified when grouping the data included in a certain data group as data to be grouped using the boundary value of the root node 21 as the boundary. The temporary maximum value in this case represents, for example, a maximum value among the data to be grouped and the data that has previously been grouped. The temporary minimum value in this case represents, for example, a minimum value among the data to be grouped and the data that has previously been grouped. If the magnitude relationships among the three values of the temporary maximum value, the temporary minimum value, and the boundary value of the root node 21 are known in this case, a binary tree (for example, a binary search tree) created according to the magnitude relationships among the three values can be used and the magnitude relationships between the data to be grouped and each of the three values can be specified in two comparisons. An example is discussed below.

First, the magnitude relationships among the temporary maximum value, the temporary minimum value, and the boundary value of the root node 21 can be depicted, for example, according to the following four ways.

(State 1) Initial state in which no data is processed. The temporary maximum value and the temporary minimum value are undefined. The boundary value of the root node 21 is defined.

(State 2) Temporary minimum value≦temporary maximum value<boundary value of the root node 21

(State 3) Boundary value of the root node 21≦temporary minimum value≦temporary maximum value

(State 4) Temporary minimum value<boundary value of the root node 21≦temporary maximum value

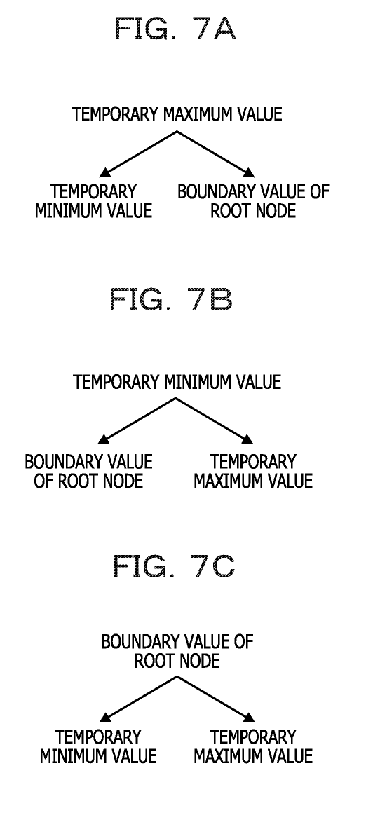

FIGS. 7A, 7B, and 7C illustrate an example of a binary tree created according to the magnitude relationships between the three values of the temporary maximum value, the temporary minimum value, and the boundary value of the root node 21. Binary trees of the temporary maximum value, the temporary minimum value, and the boundary value of the root node 21 are depicted in state 2 in FIG. 7A, state 3 in FIG. 7B, and state 4 in FIG. 7C. The control unit 600 is then able to specify the magnitude relationships between the data to be grouped and each of the temporary maximum value, the temporary minimum value, and the boundary value of the root node 21 with two comparisons by searching the binary tree crated according to the magnitude relationships corresponding to the states if the states are known.

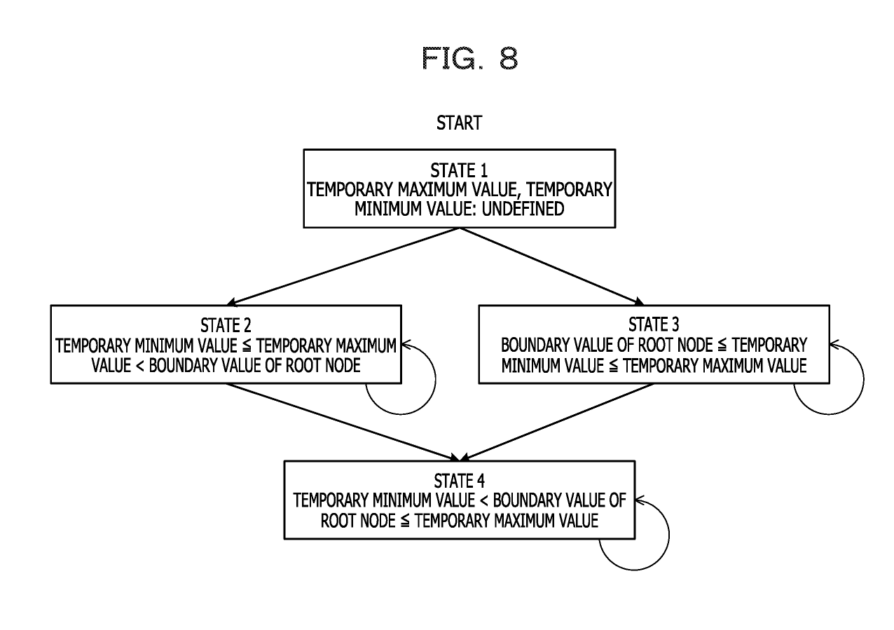

Moreover, there is a possibility that the above four states may transition when processing the data to be grouped which is read from the data group, and such transitioning occurs according to the methods depicted in FIG. 8. FIG. 8 illustrates an example of transitioning of the states. An example of the transitioning of the states and processing for grouping the data using the boundary value of the root node 21 and the boundary and an example of specifying the temporary maximum value and the temporary minimum value is discussed with reference to FIG. 7 (7A, 7B, 7C) and FIG. 8.

First, the state of the initial state in which none of the data included in the data group to be divided is processed, is the state 1 (FIG. 8). In this case, the maximum value and the minimum value are in undefined states and the value of the boundary value of the root node 21 in the binary tree is defined. In the state 1, the control unit 600 reads one data from the data group and compares the read data with the boundary value of the root node 21. When the data is less than the boundary value of the root node 21 for example, the state transitions from the state 1 to the state 2. If the data is equal to or greater than the boundary value for example, the state transitions from the state 1 to the state 3. If the state transitions to either the state 2 or the state 3, the control unit 600 sets the value of the data to both the temporary maximum value and the temporary minimum value.

If the state is the state 2, the binary tree created according to the magnitude relationships between the temporary maximum value, the temporary minimum value, and the boundary value of the root node 21 is the binary tree depicted in FIG. 7A for example. Consequently, in the state 2, the control unit 600 reads the next data from the data group and first compares the read data with the temporary maximum value that is the root node of the binary tree in FIG. 7A. If the data is less than the temporary maximum value for example, the data is smaller than the boundary value of the root node 21. As a result, the control unit 600 can omit comparing the data with the boundary value of the root node 21 and the data can be grouped into the group less than the boundary value of the root node 21. Next, the control unit 600 compares the data with the temporary minimum value that is the node that branches to the left side in FIG. 7A, and if the data is less than the temporary minimum value, updates the temporary minimum value to the value of the data. If the data to be grouped is equal to or greater than the temporary minimum value, the temporary minimum value is maintained at the current value.

Moreover, in the state 2, if the data is equal to or greater than the temporary maximum value for example, the control unit 600 updates the temporary maximum value to the value of the data. Moreover, if the data is greater than the temporary maximum value, the data does not become the temporary minimum value and the control unit 600 can omit comparing the data with the temporary minimum value. Next, the control unit 600 compares the data with the boundary value of the root node 21 that is the node of the right side branch in FIG. 7A. The control unit 600 then groups the data into the group less than the boundary value if the data is less than the boundary value. Conversely, if the data is equal to or greater than the boundary value of the root node 21, the control unit 600 groups the data into the group equal to or greater than the boundary value of the root node 21. If the data is grouped into the group equal to or greater than the boundary value of the root node 21 in the state 2, the state transitions from the state 2 to the state 4 as depicted in FIG. 8. If the data is grouped into the group less than the boundary value of the root node 21 in the state 2, the state stays in the state 2 as depicted in FIG. 8. In this case, the control unit 600 may read the next data from the data group and repeat the processing of the above state 2 with the read data as the data to be grouped.

If the state is the state 3, the binary tree created according to the magnitude relationships between the temporary maximum value, the temporary minimum value, and the boundary value of the root node 21 is the binary tree depicted in FIG. 7B for example. Consequently, in the state 3, the control unit 600 reads the next data from the data group and first compares the read data with the temporary minimum value that is the root node of the binary tree in FIG. 7B. If the data is equal to or greater than the temporary minimum value for example, the data is equal to or greater than the boundary value of the root node 21. As a result, the control unit 600 can omit comparing the data with the boundary value of the root node 21 and the data can be grouped into the group equal to or greater than the boundary value of the root node 21. Next, the control unit 600 compares the data to be grouped with the temporary maximum value that is the node that branches to the right side in FIG. 7B, and if the data is greater than the temporary maximum value, updates the temporary maximum value to the value of the data. Conversely, if the data is equal to or less than the temporary maximum value, the control unit 600 maintains the temporary maximum value as the current value.

If the data is less than the temporary minimum value for example in the state 3, the control unit 600 updates the temporary minimum value to the value of the data. Moreover, if the data is less than the temporary minimum value, the data does not become the temporary maximum value and the control unit 600 can omit comparing the data with the temporary maximum value. Next, the control unit 600 compares the data with the boundary value of the root node 21 that is the node of the right side branch in FIG. 7B. If the data is equal to or greater than the boundary value of the root node 21, the control unit 600 groups the data into the group equal to or greater than the boundary value of the root node 21. Conversely, if the data is less than the boundary value of the root node 21, the control unit 600 groups the data into the group less than the boundary value. If the data is grouped into the group of the values less than the boundary value of the root node 21 in the state 3, the state transitions from the state 3 to the state 4 as depicted in FIG. 8. If the data is grouped into the group equal to or greater than the boundary value of the root node 21 in the state 3, the state stays in the state 3 as depicted in FIG. 8. In this case, the control unit 600 may read the next data from the data group and repeat the processing of the above state 3 with the read data as the data to be grouped.

If the state is the state 4, the binary tree created according to the magnitude relationships between the temporary maximum value, the temporary minimum value, and the boundary value of the root node 21 is the binary tree depicted in FIG. 7C. Consequently, the control unit 600 reads the next data from the data group and compares the read data with the boundary value of the root node 21 that is the root node of the binary tree in FIG. 7C. If the data is equal to or greater than the boundary value of the root node 21, the control unit 600 then groups the data into the group equal to or greater than the boundary value of the root node 21. Moreover, if the data is equal to or greater than the boundary value of the root node 21, the data does not become the temporary minimum value and the control unit 600 can omit comparing the data with the temporary minimum value. Next, the control unit 600 compares the data with the temporary maximum value that is the node that branches to the right side in FIG. 7C, and if the data is greater than the temporary maximum value, updates the temporary maximum value to the value of the data. Conversely, if the data is equal to or less than the temporary maximum value, the control unit 600 maintains the temporary maximum value as the current value.

Moreover, if the data is less than the boundary value of the root node 21 for example, the control unit 600 groups the data into the group less than the boundary value of the root node 21. Moreover, if the data is less than the boundary value of the root node 21 in the state 4, the data does not become the temporary maximum value and the control unit 600 can omit comparing the data with the temporary maximum value. Next, the control unit 600 compares the data with the temporary minimum value that is the node that branches to the left side in FIG. 7C, and if the data is less than the temporary minimum value, updates the temporary minimum value to the value of the data. Conversely, if the data is equal to or greater than the temporary minimum value, the control unit 600 maintains the temporary minimum value as the current value. After the state transitions to the state 4 and stays as the state 4 as depicted in FIG. 8, the control unit 600 may read the next data from the data group and repeat the processing of the above state 4 with the read data as the data to be grouped.

As discussed above, the control unit 600 compares two values among the three values of the temporary maximum value, the temporary minimum value, and the boundary value of the root node 21 with the data to be divided based on the binary tree determined according to the magnitude relationships among the temporary maximum value, the temporary minimum value, and the boundary value of the root node 21. Consequently, the control unit 600 is able to specify the magnitude relationships between the data and each of the temporary maximum value, the temporary minimum value, and the boundary value of the root node 21 with two comparisons. When all of the data in the data group is grouped with the processing according to the above states and the temporary maximum value and the temporary minimum value have been updated, the temporary maximum value is the value that represents the maximum value of the data in the data group and the temporary minimum value is the value that represents the minimum value of the data in the data group. Therefore, the control unit 600 is able to group the data inside the data group with the boundary value of the root node 21 as the boundary, and specify the maximum value and the minimum value of the data inside the data group. Thus, the number of comparisons used to group the data included in the data group using the boundary value of the root node 21 as the boundary and to specify the maximum value and the minimum value in the data included in the data group can be reduced.

Moreover, the transitioning of the states can be specified from the magnitude relationship specified between the boundary value of the root node 21 and the data in each of the states. As a result, the control unit 600 is able to specify whether a state transitioning occurs or not without specifying, for example, whether to carry out another comparison of the magnitude relationships among the temporary maximum value, the temporary minimum value, and the boundary value of the root node 21. The processing to be executed along with the state can be changed without holding information for indicating the states in the storage unit 610 or the like by changing, for example, the action flow to be executed with a jump command and the like when a state transition occurs.

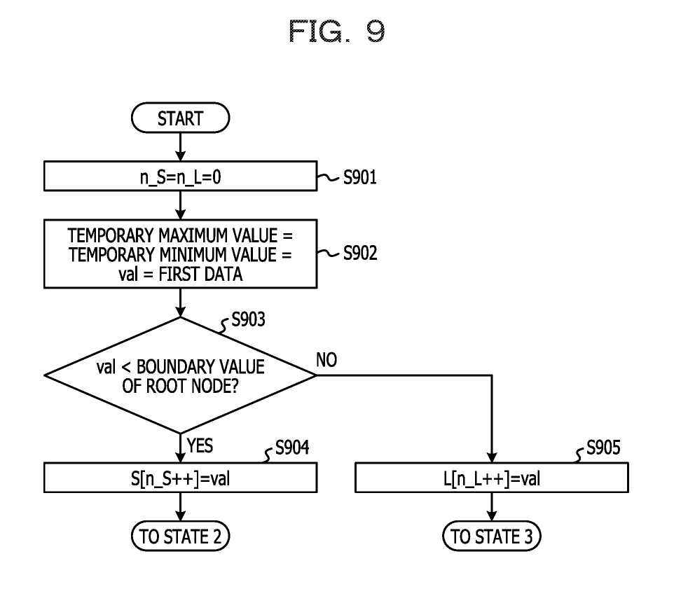

An explanation of an action flow for grouping processing based on the boundary value of the root node 21 as in the embodiment will be provided for each state from the abovementioned state 1 to the state 4 with reference to FIGS. 9 to 12. FIG. 9 illustrates an example of an action flow for a grouping process based on the boundary value of the root node 21 in the state 1. The control unit 600 in the first embodiment may start the action flow in FIG. 9 when an instruction is inputted to divide a data group having a plurality of preset boundary values as the boundaries.

In S901, the control unit 600 initializes the values of a variable n_S and a variable n_L to “0”. The variable n_S and the variable n_L are discussed in detail below. In S902, the control unit 600 reads one data from a data group to be divided and sets the data to a temporary maximum value, a temporary minimum value, and a variable val. The variable val is used as a variable for storing the data to be grouped. In S903, the control unit 600 compares the variable val with the boundary value of the root node 21 in the binary tree created using the plurality of present boundary values according to the division processing. In order to reduce the number of comparisons in correspondence to the lengths of the branches from the root node 21 to the leaf node 22 in the searching of the binary tree, the boundary value of the root node 21, for example, is preferably a boundary value close to the center of a row created when the boundary values used for the dividing are aligned in order of size.

In S903, if the variable val is less than the boundary value of the root node 21 (S903: Yes), the flow advances to S904. In S904, the control unit 600 adds 1 to the value of the variable n_S and sets the value of the variable val to an array variable S[n_S] (for example, the array variable S[1] in this case because the variable n_S=1), and the flow advances to the action flow of the state 2. However if, in S903, the variable val is equal to or greater than the boundary value of the root node 21 (S903: No), the flow advances to S905. In S905, the control unit 600 adds 1 to the value of the variable n_L and sets the value of the variable val to an array variable L[n_L] (for example, the array variable L[1] in this case because the variable n_L=1), and the flow advances to the action flow of the state 3.

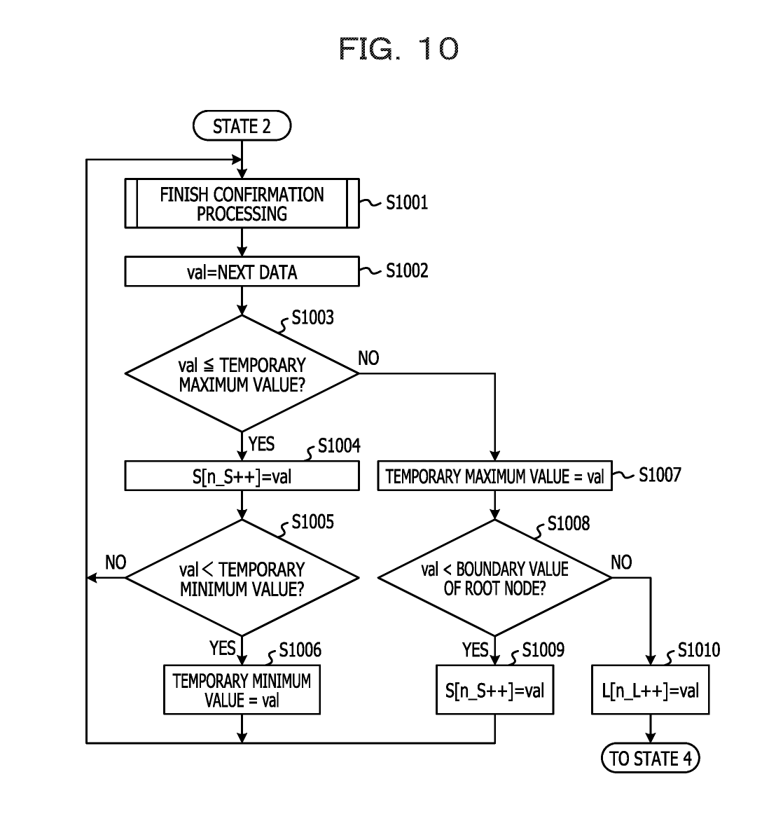

In the action flows in FIG. 9 above and in FIGS. 10 to 12 below, the variable n_S is a variable for counting the number of data having a value smaller than the boundary value of the root node 21 among the data included in the data group to be divided. The array variable S is an array variable for storing the data having a value smaller than the boundary value of the root node 21 among the data included in the data group to be divided. For example, the array variable S[n_S] is used for storing the values of the data grouped into a group of values less than the boundary value of the n_Sth root node 21. Similarly, the variable n_L is a variable for counting the number of data having a value equal to or greater than the boundary value of the root node 21 among the data included in the data group to be divided. The array variable L is an array variable for storing the data having a value equal to or greater than the boundary value of the root node 21 among the data included in the data group to be divided. For example, the array variable L[n_L] is used for storing the values of the data grouped into a group of values equal to or greater than the boundary value of the n_Sth root node 21.

FIG. 10 illustrates an example of an action flow for a grouping process based on the boundary value of the root node 21 in the state 2. In the first embodiment, the control unit 600 may start the action flow in FIG. 10 after completing the execution of the processing in S904 in FIG. 9.

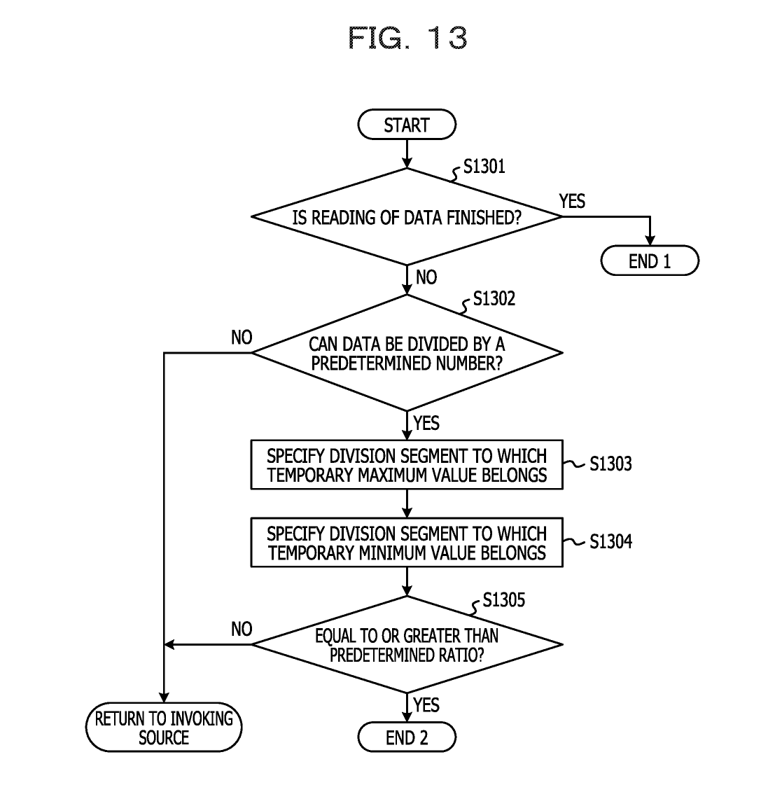

In S1001, the control unit 600 executes finish confirmation processing. Details of the finish confirmation processing are discussed below with reference to FIG. 13. If the processing is not finished as a result of executing the finish confirmation processing, the flow advances to S1002. In S1002, the control unit 600 reads the next data from the data group to be divided and sets the data to the variable val. In S1003, the control unit 600 determines whether the variable val is equal to or less than the value set to the temporary maximum value. If the variable val is a value equal to or less than the value set to the temporary maximum value (S1003: Yes), the flow advances to S1004. In S1004, the control unit 600 adds 1 to the variable n_S and sets the value of the variable to the array variable S[n_S]. In S1005, the control unit 600 determines whether the variable val is less than the value set to the temporary minimum value. If the variable val is a value equal to or greater than the value set to the temporary minimum value (S1005: No), the flow returns to S1001. However, if the variable val is a value less than the value set to the temporary minimum value (S1005: Yes), the flow advances to S1006. In S1006, the control unit 600 updates the temporary minimum value to the value set to the variable val and the flow returns to S1001.

If, in S1003, the variable val is a value greater than the value set to the temporary maximum value (S1003: No), the flow advances to S1007. In S1007, the control unit 600 updates the temporary maximum value to the value set to the variable val and the flow advances to S1008. In S1008, the control unit 600 determines whether the variable val is less than the boundary value of the root node 21. If the variable val is less than the boundary value of the root node 21 (S1008: Yes), the flow advances to S1009. In S1009, the control unit 600 adds 1 to the variable n_S and sets the value of the variable val to the array variable S[n_S], and the flow returns to S1001. However if, in S1008, the variable val is equal to or greater than the boundary value of the root node 21 (S1008: No), the flow advances to S1010. In S1010, the control unit 600 adds 1 to the variable n_L and sets the value of the variable val to the array variable L[n_L], and the flow advances to the action flow of the state 4.

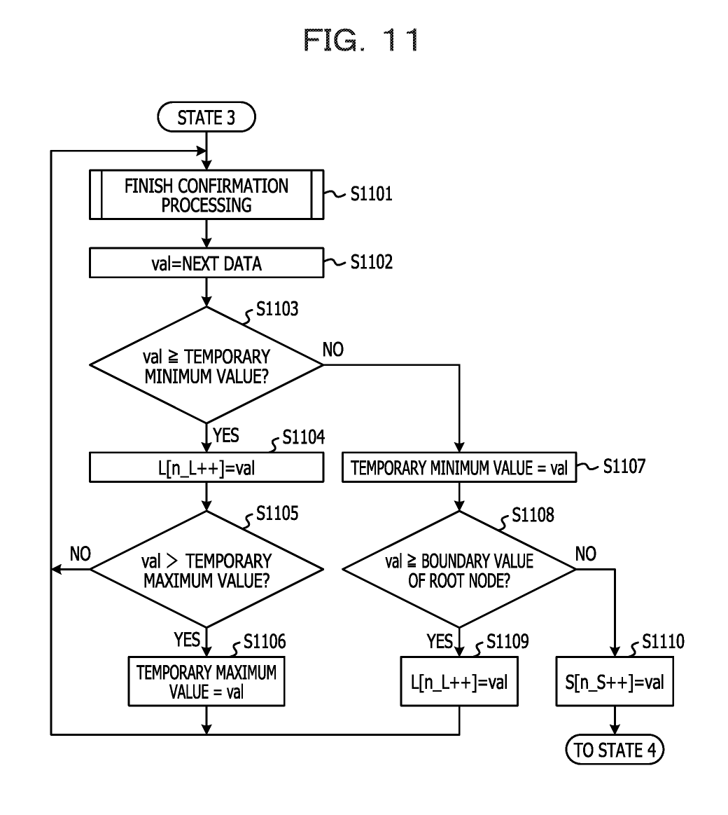

FIG. 11 illustrates an example of an action flow for a grouping process based on the boundary value of the root node 21 in the state 3. In the first embodiment, the control unit 600 may start the action flow in FIG. 11 after completing the execution of the processing in S905 in FIG. 9.

In S1101, the control unit 600 executes finish confirmation processing. Details of the finish confirmation processing are discussed below with reference to FIG. 13. Next in S1102, the control unit 600 reads the next data from the data group to be divided and sets the read next data to the variable val. In S1103, the control unit 600 determines whether the variable val is equal to or greater than the value set to the temporary minimum value. If the variable val is a value equal to or greater than the value set to the temporary minimum value (S1103: Yes), the flow advances to S1104. In S1104, the control unit 600 adds 1 to the variable n_L and sets the value of the variable to the array variable L[n_L]. In S1105, the control unit 600 determines whether the variable val is greater than the value set to the temporary maximum value. If the variable val is a value equal to or less than the value set to the temporary maximum value (S1105: No), the flow returns to S1101. However, if the variable val is a value greater than the value set to the temporary maximum value (S1105: Yes), the flow advances to S1106. In S1106, the control unit 600 updates the temporary maximum value to the value set to the variable val and the flow returns to S1101.

If, in S1103, the variable val is a value less than the value set to the temporary minimum value (S1103: No), the flow advances to S1107. In S1107, the control unit 600 updates the temporary minimum value to the value set to the variable val and the flow advances to S1108. In S1108, the control unit 600 determines whether the variable val is equal to or greater than the boundary value of the root node 21. If the variable val is equal to or greater than the boundary value of the root node 21 (S1108: Yes), the flow advances to S1109. In S1109, the control unit 600 adds 1 to the variable n_L and sets the value of the variable to the array variable L[n_L], and the flow returns to S1101. However if, in S1108, the variable val is less than the boundary value of the root node 21 (S1108: No), the flow advances to S1110. In S1110, the control unit 600 adds 1 to the variable n_S and sets the value of the variable val to the array variable S[n_S], and the flow advances to the action flow of the state 4.

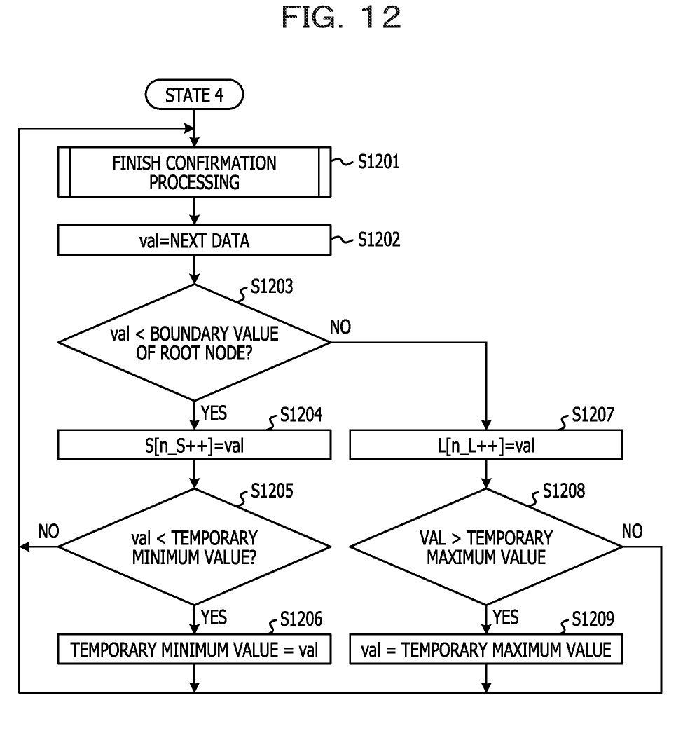

FIG. 12 illustrates an example of an action flow for a grouping process based on the boundary value of the root node 21 in the state 4. In the first embodiment, the control unit 600 may start the action flow in FIG. 12 after completing the execution of the processing in S1010 in FIG. 10 or in S1110 in FIG. 11.

In S1201, the control unit 600 executes the finish confirmation processing. Details of the finish confirmation processing are discussed below with reference to FIG. 13. If the processing is not finished as a result of executing the finish confirmation processing, the flow advances to S1202. In S1202, the control unit 600 reads the next data from the data group to be divided and sets the data to the variable val. In S1203, the control unit 600 determines whether the variable val is less than the boundary value of the root node 21. If the variable val is less than the boundary value of the root node 21 (S1203: Yes), the flow advances to S1204. In S1204, the control unit 600 adds 1 to the variable n_S and sets the value of the variable to the array variable S[n_S]. In S1205, the control unit 600 determines whether the variable val is less than the value set to the temporary minimum value. If the variable val is equal to or greater than the value set to the temporary minimum value (S1205: No), the flow returns to S1201. However, if the variable val is a value less than the value set to the temporary minimum value (S1205: Yes), the flow advances to S1206. In S1206, the control unit 600 updates the temporary minimum value to the value set to the variable val and the flow returns to S1201.

However if, in S1203, the variable val is equal to or greater than the boundary value of the root node 21 (S1203: No), the flow advances to S1207. In S1207, the control unit 600 adds 1 to the variable n_L and sets the value of the variable to the array variable L[n_L]. In S1208, the control unit 600 determines whether the variable val is greater than the value set to the temporary maximum value. If the variable val is a value equal to or less than the value set to the temporary maximum value (S1208: No), the flow returns to S1201. However, if the variable val is a value greater than the value set to the temporary maximum value (S1208: Yes), the flow advances to S1209. In S1209, the control unit 600 updates the temporary maximum value to the value set to the variable val and the flow returns to S1201.

As discussed above, when, for example, the data read from the data group to be divided is equal to or greater than the boundary value of the root node 21, the control unit 600 stores the data in the array variable L by executing any of the action flows from FIG. 9 to FIG. 12 according to the state. Moreover, when, for example, the data read from the data group to be divided is less than the boundary value of the root node 21, the control unit 600 stores the data in the array variable S. Consequently, the control unit 600 groups the data included in the data group to be divided into the data group stored in the array variable L having values equal to or greater than the boundary value of the root node 21, and into the data group stored in the array variable S having values less than the boundary value of the root node 21. Furthermore, when, for example, the data read from the data group to be divided is greater than the temporary maximum value, the control unit 600 updates the temporary maximum value to the value of the read data. When, for example, the data read from the data group to be divided is less than the temporary minimum value, the control unit 600 updates the temporary minimum value to the value of the read data.

FIG. 13 is an example of an action flow for the finish confirmation processing executed by the control unit 600. In the first embodiment, the control unit 600 may start the action flow in FIG. 13 when advancing to S1001, S1101, or S1201.

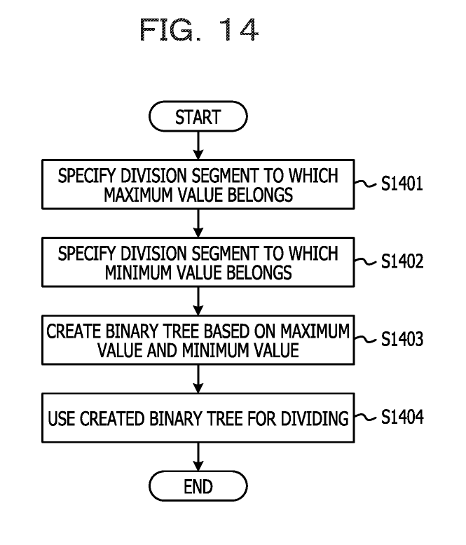

In S1301, the control unit 600 determines whether the reading of all the data from the data group to be divided is finished. If, in S1301, the reading of all the data from the data group to be divided is finished (S1301: Yes), this action flow is finished (finish 1). When the reading of all the data in the data group is finished, the temporary maximum value is the maximum value of the data in the data group because the temporary maximum value has been specified after comparing the temporary maximum value with all of the data included in the data group. Similarly, the temporary minimum value is also the minimum value of the data in the data group because the temporary minimum value has been specified after comparing the temporary minimum value with all of the data included in the data group. That is, the control unit 600 is able to specify the maximum value and the minimum value of the data included in the data group by executing any of the action flows from FIG. 9 to FIG. 12 and continually updating the temporary maximum value and the temporary minimum value. In this case, the control unit 600 may execute the action flow depicted in FIG. 14 below and may use the obtained maximum value and the minimum value of the data in the data group to complete the dividing of the data included in the data group into the division segments.

However, if in S1301, the reading of all the data from the data group to be divided is not finished (S1301: No), the flow advances to S1302. In S1302, the control unit 600 determines whether the number of the data read from the data group is divisible by a predetermined number. If the number of read data is not divisible by the predetermined number (S1302: No), the flow returns to the action flow that is the invoking source. As described above, the finish confirmation processing is invoked in S1001, S1101, or S1201. As a result, if the action flow that is the invoking source is S1001 for example, the flow may advance to S1002. Similarly, if the action flow of the invoking source is S1101, the flow may advance to S1102, or if the action flow of the invoking source is S1201, the flow may advance to S1202. Conversely, if in S1302, the number of the read data is divisible by the predetermined number (S1302: Yes), the flow advances to S1303. S1303 and S1304 are executed only when the number of the read data is divisible by the predetermined number according to the processing in S1302, that is, only when processing a portion of the data among all of the data. The determination may be carried out with a random number instead of the processing in S1302.

In S1303, the control unit 600 specifies the division segment to which the maximum value belongs from among the plurality of division segments demarcated by the plurality of preset boundary values. For example, the control unit 600 may specify to which division segment the temporary maximum value belongs by using the value set to the temporary maximum value and searching the binary tree created using the plurality of preset boundary values. In S1304, the control unit 600 specifies the division segment to which the minimum value belongs from among the plurality of division segments demarcated by the plurality of preset boundary values. For example, the control unit 600 may specify to which division segment the temporary minimum value belongs by using the value set to the temporary minimum value and searching the binary tree created using the plurality of preset boundary values.

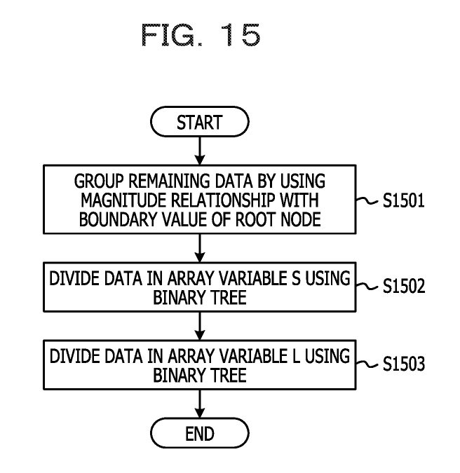

In S1305, the control unit 600 specifies the number of division segments included from the division segment to which the temporary maximum value belongs to the division segment to which the temporary minimum value belongs. The control unit 600 then determines whether the derived number of division segments is equal to or greater than a predetermined ratio with regard to the number of all the division segments demarcated by the plurality of preset boundary values from the division processing. The predetermined ratio may be 1/4 for example. In another embodiment, the determination in S1305 may be executed, for example, by determining whether the number of boundary values from the temporary maximum value to the temporary minimum value is equal to or greater than a predetermined ratio with regard to the total number of boundary values. In S1305, if the number of division segments included from the division segment to which the temporary maximum value belongs to the division segment to which the temporary minimum value belongs is less than the predetermined ratio with regard to the total number of division segments (S1305: No), the flow returns to the invoking source. However, if in S1305 the number of division segments included from the division segment to which the temporary maximum value belongs to the division segment to which the temporary minimum value belongs is equal to or greater than the predetermined ratio with regard to the total number of division segments (S1305: Yes), this action flow is finished (finish 2). In this case, the control unit 600 may execute the action flow depicted in FIG. 15 below and may complete the dividing of the data included in the data group into the division segments.

FIG. 14 illustrates an example of division completion processing using the maximum value and the minimum value. The action flow in FIG. 14 may start when, for example, the determination in S1301 in FIG. 13 is Yes (finish 1).

In S1401, the control unit 600 specifies the division segment to which the maximum value of the data included in the data group to be divided belongs from among the plurality of division segments demarcated by the plurality of preset boundary values with regard to the division processing. As described above, if Yes is determined in S1301, the temporary maximum value is specified by comparing the temporary maximum value with all of the data included in the data group and thus the value of the temporary maximum value is the maximum value of the data included in the data group. As a result, the control unit 600 in S1401 may use the value set to the temporary maximum value as the maximum value of the data included in the data group. The control unit 600 then may specify to which division segment the maximum value belongs by using the maximum value of the data included in the data group, for example, and searching the binary tree created using the plurality of preset boundary values. In S1402, the control unit 600 specifies the division segment to which the minimum value of the data included in the data group to be divided belongs from among the plurality of division segments demarcated by the plurality of preset boundary values with regard to the division processing. If Yes is determined in S1301, the temporary minimum value is specified by comparing the temporary minimum value with all of the data included in the data group and thus the value of the temporary minimum value is the minimum value of the data included in the data group. As a result, the control unit 600 in S1402 may use the value set to the temporary minimum value as the minimum value of the data included in the data group. The control unit 600 then may specify to which division segment the minimum value belongs by using the minimum value of the data included in the data group, for example, and searching the binary tree created using the plurality of preset boundary values.

Next in S1403, the control unit 600 creates a binary tree based on a boundary value between the division segment to which the maximum value of the data included in the data group belongs and the division segment to which the minimum value of the data included in the data group belongs. For example, the control unit 600 may create a binary tree based on a boundary value between the division segment to which the maximum value of the data included in the data group belongs and the division segment to which the minimum value of the data included in the data group belongs. In S1404, the control unit 600 completes the dividing by using the created binary tree and grouping the data included in the data group to be divided into the division segments, and then this action flow is finished.

In the processing in S1403 and 1404, the boundary value of the root node 21 of the binary tree created from the plurality of present boundary values may be included, for example, between the minimum value and the maximum value of the data included in the data group. In this case, the results of the groupings using the boundary value of the root node 21 as a boundary are stored in the array variable S and the array variable L, and thus the number of comparisons can be reduced by using these results.

For example, the control unit 600 uses a boundary value equal to or greater than the minimum value of the data included in the data group and smaller than the boundary value of the root node 21 to create a binary tree. The control unit 600 then may specify a division segment that is a grouping destination of the data included in the array variable S by using the data included in the array variable S to search the obtained binary tree. Moreover, the control unit 600 uses, for example, a boundary value equal to or less than the maximum value of the data included in the data group and greater than the boundary value of the root node 21 to create a binary tree. The control unit 600 then may specify a division segment that is a grouping destination of the data included in the array variable L by using the data included in the array variable L to search the obtained binary tree.

FIG. 15 illustrates an example of second division completion processing. The action flow in FIG. 15 may start when Yes is determined in S1305 in FIG. 13 (finish 2).

In S1501, the control unit 600 groups the remaining data that has not yet been grouped in the array variable S or the array variable L among the data included in the data group to be divided, by the boundary of the boundary value of the root node 21. For example, if the data to be grouped is less than the boundary value of the root node 21, the control unit 600 adds 1 to the value of the variable n_S and sets the data to be grouped to the array variable S[n_S]. Conversely, if the data to be grouped is equal to or greater than the boundary value of the root node 21, the control unit 600, for example, adds 1 to the value of the variable n_L and sets the data to be grouped to the array variable L[n_L]. In S1502, the control unit 600 may group the data stored in the array variable S into a division segment by searching from the child node on the left side of the root node 21 in the binary tree created by using the plurality of preset boundary values with regard to the division processing. Moreover in S1503, the control unit 600 may group the data stored in the array variable L into a division segment by searching from the child node on the right side of the root node 21 in the binary tree created by using the plurality of preset boundary values with regard to the division processing. This action flow is finished when the processing in S1503 is completed.

As described above, the control unit 600 in the above embodiment combines the processing for specifying the temporary maximum value and the temporary minimum value with the grouping of the data to be grouped based on the boundary value of the root node 21 of the binary tree. Consequently, the control unit 600, for example, is able to reduce the number of comparisons used for grouping the data included in the data group based on the boundary value of the root node 21 and for specifying the maximum value and the minimum value of the data included in the data group.

For example, when a certain data is grouped using the boundary value of the root node 21 as a boundary individually according to whether the data is the maximum value or the minimum value in the data group, it is estimated that three comparisons are carried out for each data. However, in the above embodiment, the control unit 600 compares the data to be grouped with two values among the three values determined by the binary tree created according to the magnitude relationship of the three values of the boundary value of the root node 21, the temporary maximum value, and the temporary minimum value. As a result, the control unit 600 specifies the group using the boundary value of the root node 21 as the boundary, the temporary maximum value, and the temporary minimum value. Therefore, the number of comparisons can be reduced to two according to the embodiment.

Furthermore, for example, the magnitude relationships among the temporary maximum value, the temporary minimum value, and the boundary value of the root node 21 are aligned in the order from the smallest to the largest as the temporary minimum value, the temporary maximum value, and the boundary value of the root node 21. In this case, the control unit 600 compares the data to be grouped with the temporary maximum value, and if the data to be grouped is less than the temporary maximum value, the data can be grouped in the group less than the boundary value of the root node 21 without comparing the data to be grouped with the boundary value of the root node 21. Conversely, if the data to be grouped is larger than the temporary maximum value, the control unit 600 is able to omit comparing the data to be grouped with the temporary minimum value because the data to be grouped is not the temporary minimum value.

Furthermore, for example, the magnitude relationships among the temporary maximum value, the temporary minimum value, and the boundary value of the root node 21 are aligned in the order from the smallest to the largest as the boundary value of the root node 21, the temporary minimum value, and the temporary maximum value. In this case, the control unit 600 compares the data to be grouped with the temporary minimum value, and if the data to be grouped is greater than the temporary minimum value, the data can be grouped in the group greater than the boundary value of the root node 21 without comparing the data to be grouped with the boundary value of the root node 21. Conversely, if the data to be grouped is less than the temporary minimum value, the control unit 600 is able to omit comparing the data to be grouped with the temporary maximum value because the data to be grouped is not the temporary maximum value.

Furthermore, for example, the magnitude relationships among the temporary maximum value, the temporary minimum value, and the boundary value of the root node 21 are aligned in the order from the smallest to the largest as the temporary minimum value, the boundary value of the root node 21, and the temporary maximum value. In this case, if the data to be grouped is compared with the boundary value of the root node 21 and the data to be grouped is less than the boundary value of the root node 21, the control unit 600 is able to omit comparing the data to be grouped with the temporary maximum value because the data to be grouped is not the temporary maximum value. Conversely, if the data to be grouped is larger than the boundary value of the root node 21, the control unit 600 is able to omit comparing the data to be grouped with the temporary minimum value because the data to be grouped is not the temporary minimum value.

Moreover, in the above embodiment, if the number of division segments included from the division segment to which the temporary maximum value belongs to the division segment to which the temporary minimum value belongs in S1305 is equal to or greater than the predetermined ratio with regard to the total number of division segments, the flow advances to the action flow in FIG. 15. As a result, the control unit 600 stops specifying the temporary maximum value and the temporary minimum value. For example, when the read data is spread over all of the plurality of division segments demarcated by the plurality of preset boundary values with regard to the division processing at the point in time when the reading of the data from the data group to be divided is finished to a certain degree, the number of boundary values outside of the area between the maximum value and the minimum value is smaller. As a result, the obtained effect of reducing the amount of calculations by reducing the boundary values used for creating the binary tree is reduced as mentioned with regard to FIG. 4. Conversely, when deriving the maximum value and the minimum value of the data included in the data group to be divided, comparisons are carried out for deriving the maximum value and the minimum value. However in the above embodiment, the control unit 600 confirms a bias in the read data at the point in time the reading of the data from the data group to be divided is finished to a certain degree. When the data is spread over a wide area of the plurality of division segments demarcated by the plurality of preset boundary values among the read data, the control unit 600 stops specifying the temporary maximum value and the temporary minimum value. As a result the control unit 600 is able to inhibit executing comparisons for deriving the maximum value and the minimum value, for example, under a condition in which it assumed that the boundary value used in the binary tree for dividing is not sufficiently thinned out from the plurality of preset boundary values. As a result, the control unit 600 is able to reduce the number of comparisons.

Therefore according to the embodiment, the control unit 600 is able to, for example, detect a bias of the data included in the data group and reduce the number of comparisons when dividing the data in the data group using the binary tree.

The explanations of the above examples use numerical values as the examples of the data. However, the data that can be used with the embodiment is not limited as such and the embodiment may be applied to data other than numerical values. For example, the data may be character string or dates and data may be used in which the magnitude relationships are defined according to alphabetic order, the order of the Japanese alphabet, or by order of the oldest or newest dates. For example, data that satisfies the following conditions may be used as the data to be divided.

(a) A magnitude relationship is defined between an element A and an element B when the element A and the element B which are any two elements in a collection are extracted. The magnitude relationship indicates whether the element A is smaller than the element B (which is the same as the element B being greater than the element A), whether the element A is the same as the element B, or whether the element A is greater than the element B (which is the same as the element B being less than the element A).

(b) When arbitrary elements A, B, and C are extracted from a collection, if the element A is smaller than the element B and the element B is smaller than the element C, the element A is defined as being smaller than the element C.

Moreover, when the element A in the collection satisfies the following condition, the element A is understood to be the maximum value of the collection.

(c) The element A is greater than the element B or the element A is the same as the element B with regard to an arbitrary element B in the collection.

Similarly, when the element A in the collection satisfies the following condition, the element A is understood to be the minimum value of the collection.

(d) The element A is less than the element B or the element A is the same as the element B with regard to an arbitrary element B in the collection.

Further, data that can be used in the embodiment may be, for example, a numeral or a character string, or may be a value of a portion of an element in a table or a database and the like registered and associated with a plurality of elements such as the product numbers in the sales database 300 in FIG. 3.

The data of a data group to be divided is compared with two values determined by a binary tree created according to the magnitude relationships among a temporary maximum value, a temporary minimum value, and a boundary value of the root node 21, whereby the number of comparisons is reduced in the above embodiment. However, the embodiment is not limited as such. For example, it can be assumed that the order of comparing the data with the boundary value of the root node 21, the temporary maximum value, and the temporary minimum value is determined and the comparison is carried out in the sequence of the boundary value of the root node 21, the temporary maximum value, and the temporary minimum value. In this case for example, if there are two states, it can be known when comparing the data with the boundary value of the root node 21 that the data is greater than the temporary maximum value and the temporary minimum value even without comparing the data with the temporary maximum value and the temporary minimum value if the data is greater than the boundary value of the root node 21. In this way, the processing can be executed while reducing the number of comparisons by using, for example, the information of the magnitude relationships among the temporary maximum value, the temporary minimum value, and the boundary value of the root node 21 in each state.

While an embodiment has been exemplified above, the embodiment is not limited as such. For example, the above action flows are examples and the embodiment is not limited to the above action flows. For example, when possible, the action flows may be executed while changing the order of the processing, other processing may be included, or a portion of the processing may be omitted. For example, in another embodiment, the sequence of the processing in S901 and the processing in S902 may be replaced and executed. Similarly, the respective sequences of the processing in S1303 and the processing in S1304, the processing in S1401 and the processing in S1402, or the processing in S1502 and the processing in S1503 may be replaced and executed.

Moreover, while grouping the data to the greater side of the boundary value when the data to be grouped is equal to the boundary value is presented in the above examples, the embodiment is not limited in this way. For example, when the data to be grouped is equal to the boundary value, the control unit 600 may sort the data to the side smaller than the boundary value in another embodiment.

The control unit 600 in the above action flows in FIGS. 9 to 12 may operate as the specifying unit 601. The control unit 600 in the action flow in FIG. 14 may operate as the dividing unit 602 for example.

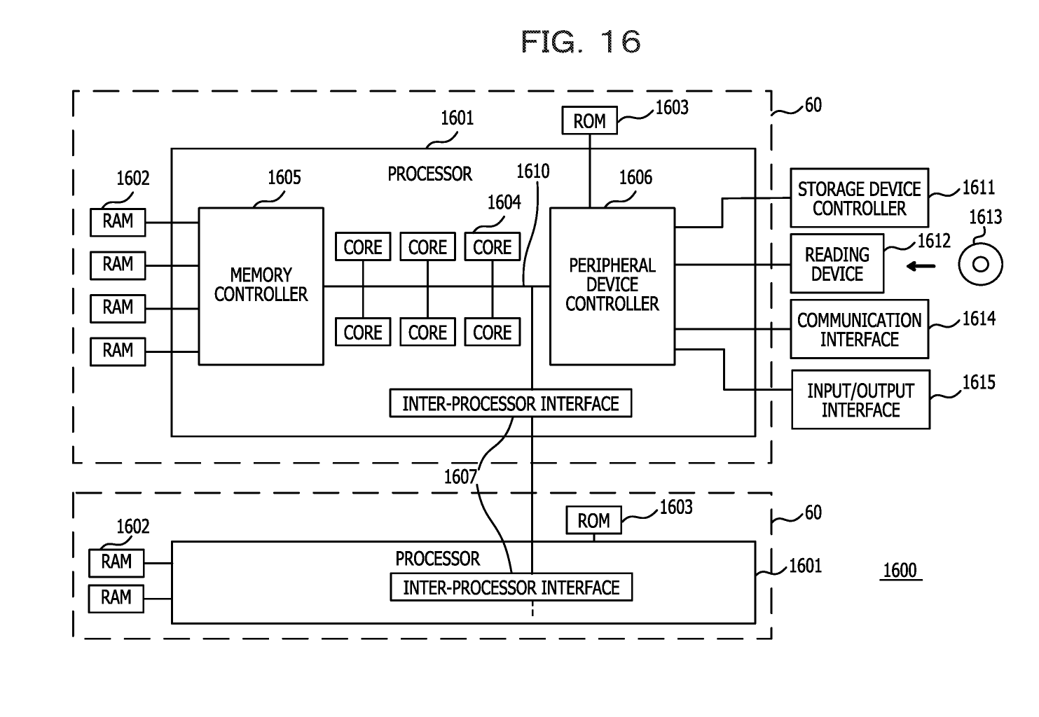

FIG. 16 illustrates an example of a hardware configuration of a system 1600 according to a first embodiment. The system 1600 may include, for example, a plurality of information processor apparatuses 60. The information processing apparatus 60 may be, for example, a computer in which a database system can operate. The information processing apparatus 60 is provided with a processor 1601, a RAM 1602, and a ROM 1603 for example. RAM is an abbreviation for random access memory. ROM is an abbreviation for read only memory. The processor 1601 may be provided with at least one core 1604, a memory controller 1605, a peripheral device controller 1606, and an inter-processor interface 1607, and these elements may be connected over a bus 1610. The processors 1601 may be connected to each other through inter-processor interfaces 1607 for example. The memory controller 1605 is connected to the RAM 1602 for example and may access the RAM 1602.

The processor 1601 may execute the above action flow processing, for example, by using the RAM 1602 and executing a program in which is written the procedures of the above action flows. In the first embodiment, the control unit 600 may be the processor 1601 for example. The storage unit 610 may be the RAM 1602 for example.

The peripheral device controller 1606 may be connected to the ROM 1603 for example. Moreover, the peripheral device controller 1606 may be connected to a storage device controller 1611 for example. The storage device controller 1611 may be connected to an external storage device such as a hard disk for example, and may read and write data to the external storage device according to an instruction from the processor 1601. Moreover, the peripheral device controller 1606 may be connected to a reading device 1612. The reading device 1612 accesses a portable recording medium 1613 according to an instruction from the processor 1601 for example. The portable storage medium 1613 may be realized for example by a semiconductor device (for example, a USB memory), a medium in which information is input and output through magnetic actions (for example, a magnetic disc), or medium in which information is input and output through optical actions (for example, a CD-ROM or DVD). USB is an abbreviation for a universal serial bus. CD is an abbreviation for a compact disk. DVD is an abbreviation for a digital versatile disk.

The peripheral device controller 1606 may be connected to a communication interface 1614 for example. The communication interface 1614 may send and receive data over a network according to an instruction from the processor 1601 for example. The peripheral device controller 1606 may be connected to an input/output interface 1615 for example, and the input/output interface 1615 may be an interface with an input device and an output device for example. The input device may be a device such as an input key or a touch panel and the like that receives inputs from a user for example. The output device may be a display device such as a display or a touch panel for example, or may be a printing device such as a printer and the like.

The programs according to the embodiment for causing the processor 1601 to execute the above mentioned action flows and the plurality of pieces of data to be divided for example, may be supplied to the information processing apparatus 60 in the following forms.

(1) Stored in an external storage device connected to the storage device controller 1611.

(2) Supplied by a server over a network.

(3) Supplied by the portable recording medium 1613.

The system 1600 in FIG. 16 may include a plurality of information processor apparatuses 60 and may execute the abovementioned action flows in units of the processors 1601 included in the information processing apparatus 60. Concurrent processing may be realized by the action flows according to the embodiment being executed by the respective plurality of processors 1601. However, the embodiment is not limited in this way and, for example, the concurrent processing may be executed in units of the cores 1604. In this case, the core 1604 may function as the information processing apparatus 60 according to the embodiment. In another embodiment, concurrent processing may be realized by causing each of a plurality of computers connected to a network to execute the action flows according to the embodiment. Alternatively, concurrent processing may be realized by causing the action flows according to the embodiment to be executed by a plurality of virtual machines. In this case, the computers or the virtual machines may function as the information processing apparatus 60 according to the embodiment.

Moreover, several embodiments including the above embodiment are to be understood by a person skilled in the art as containing various modifications and substitutions of the above embodiment. For example, the embodiments may be embodied by changes in the constituent elements. Moreover, various embodiments may be carried out by combining as appropriate the plurality of constituent elements disclosed in the abovementioned embodiments. Furthermore, various embodiments may be carried out by removing or substituting various constituent elements from among all of the constituent elements presented in the embodiment, or by adding several constituent elements to the constituent elements presented in the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable medium storing a program that causes one or more processors included in a computer to execute a process, the process comprising:
reading, when each of a plurality of pieces of data is set as target data to be grouped and the target data is grouped based on a boundary value of a root node in a binary tree created from a plurality of boundary values, the target data from the plurality of pieces of data;
specifying a temporary maximum value that indicates a maximum value among the target data and data already grouped, and a temporary minimum value that indicates a minimum value among the target data to be grouped and the data already grouped;
specifying a maximum value and a minimum value of the plurality of pieces of data by updating the temporary maximum value and the temporary minimum value;
dividing the plurality of pieces of data based on a boundary value between the maximum value and the minimum value of the plurality of pieces of data among the plurality of boundary values; and
allocating the divided plurality of pieces of data to a plurality of processing devices that carry out processing on each of the divided plurality of data.

2. The non-transitory computer readable medium according to claim 1, wherein
the specifying of the maximum value and the minimum value of the plurality of pieces of data includes grouping the target data and specifying the temporary maximum value and the temporary minimum value by comparing, with the target data to be grouped and two values among three values which are determined according to a binary tree created according to magnitude relationships among the three values of the boundary value of the root node, the temporary maximum value, and the temporary minimum value.

3. The non-transitory computer readable medium according to claim 2, wherein
when the magnitude relationship among the three values is in the order from smallest to largest of the temporary minimum value, the temporary maximum value, and the boundary value of the root node, the specifying of the maximum value and the minimum value of the plurality of pieces of data includes:
grouping the target data into a group smaller than the boundary value of the root node when the target data to be grouped is smaller than the temporary maximum value, and comparing the target data with the temporary minimum value and updating the temporary minimum value to the target data when the target data is smaller than the temporary minimum value; and
updating the temporary maximum value to the target data when the target data is larger than the temporary maximum value, and comparing the target data with the boundary value of the root node and grouping the target data into a group larger than the boundary value of the root node or a group smaller than the boundary value of the root node.

4. The non-transitory computer-readable medium according to claim 2, wherein
when the magnitude relationship among the three values is, in the order from smallest to largest, the boundary value of the root node, the temporary minimum value, and the temporary maximum value, the specifying the maximum value and the minimum value of the plurality of pieces of data includes:
grouping the target data into a group larger than the boundary value of the root node when the target data to be grouped is larger than the temporary minimum value, and comparing the target data with the temporary maximum value and updating the temporary maximum value to the target data when the target data is greater than the temporary maximum value; and
updating the temporary minimum value to the target data when the target data is smaller than the temporary minimum value, and comparing the target data with the boundary value of the root node and grouping the target data into the group larger than the boundary value of the root node or the group smaller than the boundary value of the root node.

5. The non-transitory computer-readable medium according to claim 2, wherein
when the magnitude relationship among the three values is, in the order from smallest to largest, the temporary minimum value, the boundary value of the root node, and the temporary maximum value, the specifying the maximum value and the minimum value of the plurality of pieces of data includes:
grouping the target data into a group smaller than the boundary value of the root node when the target data is smaller than the boundary value of the root node, and comparing the target data with the temporary minimum value and updating the temporary minimum value to the target data when the target data is smaller than the temporary minimum value; and
grouping the target data into a group larger than the boundary value of the root node when the target data is larger than the boundary value of the root node, and comparing the target data with the temporary maximum value and updating the temporary maximum value to the target data when the target data is larger than the temporary maximum value.

6. The non-transitory computer readable medium according to claim 1, wherein
when the number of division segments included from a division segment to which the temporary maximum value belongs to a division segment to which the temporary minimum value belongs among a plurality of division segments demarcated by the plurality of boundary values, the specifying of the temporary maximum value and the temporary minimum value is stopped.

7. The non-transitory computer readable medium according to claim 1, wherein the process further comprising:
collecting a result of a sort process on data allocated to the plurality of processing devices;
creating a sorting result of the plurality of pieces of data by merging the collected plurality of processing results; and
storing the created sorting result in a memory.

8. A method comprising:
reading, when each of a plurality of pieces of data is set as target data to be grouped and the target data is grouped based on a boundary value of a root node in a binary tree created from a plurality of boundary values, the target data from the plurality of pieces of data;
specifying, by a processor, a temporary maximum value that indicates a maximum value among the target data and data already grouped, and a temporary minimum value that indicates a minimum value among the target data to be grouped and the data already grouped;
specifying, by the processor, a maximum value and a minimum value of the plurality of pieces of data by updating the temporary maximum value and the temporary minimum value;
dividing, by the processor, the plurality of pieces of data based on a boundary value between the maximum value and the minimum value of the plurality of pieces of data among the plurality of boundary values; and
allocating, by the processor, the divided plurality of pieces of data to a plurality of processing devices that carry out processing on each of the divided plurality of data.

9. The method according to claim 8, wherein
the specifying of the maximum value and the minimum value of the plurality of pieces of data includes grouping the target data and specifying the temporary maximum value and the temporary minimum value by comparing, with the target data to be grouped and two values among three values which are determined according to a binary tree created according to magnitude relationships among the three values of the boundary value of the root node, the temporary maximum value, and the temporary minimum value.

10. The method according to claim 9, wherein
when the magnitude relationship among the three values is in the order from smallest to largest of the temporary minimum value, the temporary maximum value, and the boundary value of the root node, the specifying of the maximum value and the minimum value of the plurality of pieces of data includes:
grouping the target data into a group smaller than the boundary value of the root node when the target data to be grouped is smaller than the temporary maximum value, and comparing the target data with the temporary minimum value and updating the temporary minimum value to the target data when the target data is smaller than the temporary minimum value; and
updating the temporary maximum value to the target data when the target data is larger than the temporary maximum value, and comparing the target data with the boundary value of the root node and grouping the target data into a group larger than the boundary value of the root node or a group smaller than the boundary value of the root node.

11. The method according to claim 9, wherein
when the magnitude relationship among the three values is, in the order from smallest to largest, the boundary value of the root node, the temporary minimum value, and the temporary maximum value, the specifying the maximum value and the minimum value of the plurality of pieces of data includes:
grouping the target data into a group larger than the boundary value of the root node when the target data to be grouped is larger than the temporary minimum value, and comparing the target data with the temporary maximum value and updating the temporary maximum value to the target data when the target data is larger than the temporary maximum value; and
updating the temporary minimum value to the target data when the target data is smaller than the temporary minimum value, and comparing the target data with the boundary value of the root node and grouping the target data into the group larger than the boundary value of the root node or the group smaller than the boundary value of the root node.

12. The method according to claim 9, wherein
when the magnitude relationship among the three values is, in the order from smallest to largest, the temporary minimum value, the boundary value of the root node, and the temporary maximum value, the specifying the maximum value and the minimum value of the plurality of pieces of data includes:
grouping the target data into a group smaller than the boundary value of the root node when the target data is smaller than the boundary value of the root node, and comparing the target data with the temporary minimum value and updating the temporary minimum value to the target data when the target data to be grouped is smaller than the temporary minimum value; and
grouping the target data into a group larger than the boundary value of the root node when the target data is larger than the boundary value of the root node, and comparing the target data with the temporary maximum value and updating the temporary maximum value to the target data when the target data is larger than the temporary maximum value.

13. The method according to claim 8, further comprising:
collecting a result of a sort process on data allocated to the plurality of processing devices;
creating a sorting result of the plurality of pieces of data by merging the collected plurality of processing results; and
storing the created sorting result in a memory.

14. An information processing apparatus comprising:
a memory; and
a processor coupled to the memory and configured to:
read, when each of a plurality of pieces of data is set as target data to be grouped and the target data is grouped based on a boundary value of a root node in a binary tree created from a plurality of boundary values, the target data to be grouped from the plurality of pieces of data,
specify a temporary maximum value that indicates a maximum value among the target data and data already grouped, and a temporary minimum value that indicates a minimum value among the target data to be grouped and the data already grouped,
specify a maximum value and a minimum value of the plurality of pieces of data by updating the temporary maximum value and the temporary minimum value,
divide the plurality of pieces of data based on a boundary value between the maximum value and the minimum value of the plurality of pieces of data among the plurality of boundary values, and
allocate the divided plurality of pieces of data to a plurality of processing devices that carry out processing on each of the divided plurality of data.

15. The information processing apparatus according to claim 14, wherein the processor is configured to:
specify the maximum value and the minimum value of the plurality of pieces of data by grouping the target data and specifying the temporary maximum value and the temporary minimum value by comparing, with the target data to be grouped and two values among three values which are determined according to a binary tree created according to magnitude relationships among the three values of the boundary value of the root node, the temporary maximum value, and the temporary minimum value.

16. The information processing apparatus according to claim 15, wherein
when the magnitude relationship among the three values is in the order from smallest to largest of the temporary minimum value, the temporary maximum value, and the boundary value of the root node, the processor is configured to specify the maximum value and the minimum value of the plurality of pieces of data by
grouping the target data into a group smaller than the boundary value of the root node when the target data to be grouped is smaller than the temporary maximum value, and comparing the target data with the temporary minimum value and updating the temporary minimum value to the target data when the target data is smaller than the temporary minimum value; and
updating the temporary maximum value to the target data when the target data is larger than the temporary maximum value, and comparing the target data with the boundary value of the root node and grouping the target data into a group larger than the boundary value of the root node or a group smaller than the boundary value of the root node.

17. The information processing apparatus according to claim 15, wherein
when the magnitude relationship among the three values is, in the order from smallest to largest, the boundary value of the root node, the temporary minimum value, and the temporary maximum value, the processor is configured to specify the maximum value and the minimum value of the plurality of pieces of data by
grouping the target data into a group larger than the boundary value of the root node when the target data is larger than the temporary minimum value, and comparing the target data with the temporary maximum value and updating the temporary maximum value to the target data when the target data is larger than the temporary maximum value; and
updating the temporary minimum value to the target data when the target data is smaller than the temporary minimum value, and comparing the target data with the boundary value of the root node and grouping the target data into the group larger than the boundary value of the root node or the group smaller than the boundary value of the root node.

18. The information processing apparatus according to claim 15, wherein:
when the magnitude relationship among the three values is, in the order from smallest to largest, the temporary minimum value, the boundary value of the root node, and the temporary maximum value, the processor is configured to specify the maximum value and the minimum value of the plurality of pieces of data by
grouping the target data into a group smaller than the boundary value of the root node when the target data is smaller than the boundary value of the root node, and comparing the target data with the temporary minimum value and updating the temporary minimum value to the target data when the target data is smaller than the temporary minimum value; and
grouping the target data into a group larger than the boundary value of the root node when the target data is larger than the boundary value of the root node, and comparing the target data with the temporary maximum value and updating the temporary maximum value to the target data when the target data is larger than the temporary maximum value.

19. The information processing apparatus according to claim 14, wherein the processor is further configured to:
collect a result of a sort process on data allocated to the plurality of processing devices,
create a sorting result of the plurality of pieces of data by merging the collected plurality of processing results, and
store the created sorting result in a memory.
